(19) United States
(12) Patent Application Publication
(10) Pub. No.: US 2020/0276986 A1
(43) Pub. Date: Sep. 3, 2020

(54) DISTRIBUTING DEVICE AND METHOD FOR DISTRIBUTING DATA STREAMS FOR A CONTROL UNIT FOR A VEHICLE DRIVABLE IN A HIGHLY AUTOMATED MANNER

(71) Applicant: Robert Bosch GmbH, Stuttgart (DE)

(72) Inventors: Florian Kraemer, Pfedelbach (DE); Jaroslaw Topp, Renningen (DE); Rainer Schittenhelm, Ilvesheim (DE); Robert Kornhaas, Spraitbach (DE); Ulrich Kersken, Diekholzen (DE)

(21) Appl. No.: 16/649,765

(22) PCT Filed: Sep. 10, 2018
(86) PCT No.: PCT/EP2018/074289

§ 371 Date: May 6, 2020

(30) Foreign Application Priority Data
Sep. 26, 2017 (DE) 10 2017 217 016.6

(51) Int. Cl. B60W 60/00; G06F 9/50

(52) U.S. Cl. CPC B60W 60/0016; G06F 9/5027; B60W 2420/00; B60W 2400/00; B60W 2556/00

(57) ABSTRACT

A distributing device for distributing data streams for a control unit for a vehicle drivable in a highly automated manner. The distributing device includes at least one first processor unit and at least one further processor unit, which are designed to process sensor data streams. The distributing device also includes a distributing unit, which is designed to read in a first sensor data stream of at least one first sensor and at least one further sensor data stream of at least one further sensor and to distribute them optionally onto the at least one first processor unit or the at least one further processor unit.

### FIELD

The present invention is directed to a device and a method for distributing data streams. The present invention also relates to a computer program.

### BACKGROUND INFORMATION

In present central control units for safety-critical applications for vehicles, also called “driver assistance systems,” combinations of a microcontroller and a microprocessor are used. Special precautions for distributing the data streams are not yet necessary here, since each unit has its dedicated task and dedicated interfaces. Even in the case of multiple processors, there are fixed distributions of the tasks in the system.

### SUMMARY

The present invention provides a distributing device for distributing data streams for a control unit for a vehicle drivable in a highly automated manner, furthermore a method for distributing data streams for a control unit for a vehicle drivable in a highly automatic manner, and a corresponding computer program. Advantageous refinements and improvements of the distributing device are described herein.

Advantages achievable by example embodiments of the present invention include that even very large data streams may be distributed and processed rapidly and efficiently without bottlenecks by the example distributing device provided here. This may be important in particular for a control unit for safety-critical applications and driver assistance systems of vehicles, in order to ensure or increase a level of safety of occupants of the vehicle.

In accordance with an example embodiment of the present invention, a distributing device for distributing data streams for a control unit for a vehicle drivable in a highly automated manner includes at least one first processor unit and at least one further processor unit, which are designed to process sensor data streams. Moreover, the distributing device includes a distributing unit, which is designed to read in a first sensor data stream of at least one first sensor and at least one further sensor data stream of at least one further sensor and distribute them optionally to the at least one first processor unit or the at least one further processor unit.

The first processor unit and/or the further processor unit may each be a processor. The distributing unit may be formed as a so-called switch, for example, a low-latency PCIe switch (PCI=peripheral component interconnect), which is designed to distribute the first data stream optionally to the first processor unit or the further processor unit and the further data stream optionally to the first processor unit or the further processor unit. The distributing unit and the processor units may be connected to one another, for example, via a PCI bus. An optional allocation may be understood to mean that a sensor data stream may be associated with either the first or the further processor unit depending on a present state of the distributing device. For example, the sensor data stream may be associated depending on a present utilization of the individual processor units to that processor unit which presently has free processor capacity. Thanks to such a distributing unit, the sensor data streams may be allocated onto multiple processor units, whereby bottlenecks advantageously do not occur.

The example distributing device may furthermore include a first channeling unit, which is designed to channel a sensor raw data stream from at least the first sensor to the first sensor data stream and may include a further channeling unit, which is designed to channel a further sensor raw data stream from at least the further sensor to the further sensor data stream. The channeling units may each be coupled with the aid of PCI to the distributing unit and may be formed as programmable FPGAs, to be able to channel a plurality of data streams. The interfaces of the distributing unit may be kept to a minimum by the channeling units.

If the distributing device additionally includes at least one connecting unit, which is designed to connect the first processor unit and/or the further processor unit to at least one vehicle unit and/or at least one further processing device, this may enable something to be effectuated or controlled in the vehicle by the processed data streams and/or, for example, a cascaded further processing of the processed data streams may take place in the further processing device. A processed data stream may thus include, for example, a control signal for an actuator of the vehicle. To transfer very many processed data streams quickly, the connecting device may include at least one Ethernet interface and/or one Ethernet cable.

According to one advantageous specific embodiment of the present invention, the example distributing device may also include the vehicle unit and/or the further processing device. The vehicle unit may be an actuator. The further processing device may be an additional processor unit, which may be designed to read in the data streams processed by the first processor unit or the at least one further processor unit, process them again, and provide them for the vehicle unit and/or a further vehicle unit. The vehicle unit and/or the further vehicle unit may include, for example, a trigger unit for a passenger protection system. This trigger unit may effectuate particularly rapid triggering of a passenger protection means such as an airbag by way of the distributing device according to the present invention.

The distributing device may also include the first sensor and the further sensor. The first sensor may be, for example, a surroundings detection device and the further sensor may be an acceleration sensor.

An example method in accordance with the present invention for distributing data streams for a control unit for a vehicle drivable in a highly automatic manner includes at least the following steps:

reading in and optionally distributing at least one first sensor data stream of at least one first sensor and at least one further sensor data stream of at least one further sensor onto at least one first processor unit or a further processor unit; and
processing the sensor data streams.

This method may be implemented, for example, in software or hardware or in a mixed form of software and hardware, for example, in a control unit, for example, of the above-described distributing device. The underlying object of the approach may also be achieved rapidly and efficiently by such a method.

A computer program product or computer program having program code which may be stored on a machine-readable carrier or storage medium such as a semiconductor memory, a hard drive memory, or an optical memory and is used to carry out, implement, and/or control the steps of the method according to one of the above-describe specific embodiments, in particular if the program product or program is executed on a computer or a device, is also advantageous.

Exemplary embodiments of the present invention are shown in the figures and are explained in greater detail below.

### BRIEF DESCRIPTION OF THE DRAWINGS

FIG. 1 shows a block diagram of a distributing device for distributing data streams for a control unit for a vehicle drivable in a highly automatic manner according to one exemplary embodiment.

FIG. 2 shows a block diagram of a distributing device having a further processing device according to one exemplary embodiment.

FIG. 3 shows a flow chart of a method for distributing data streams for a control unit for a vehicle drivable in a highly automated manner according to one exemplary embodiment.

### DETAILED DESCRIPTION OF EXAMPLE EMBODIMENTS

In the following description of advantageous exemplary embodiments of the present approach, identical or similar reference numerals are used for the elements illustrated in the various figures and acting similarly, a repeated description of these elements being omitted.

If an exemplary embodiment includes an “and/or” linkage between a first feature and a second feature, this is thus to be read to mean that the exemplary embodiment according to one specific embodiment includes both the first feature and the second feature and according to a further specific embodiment includes either only the first feature or only the second feature.

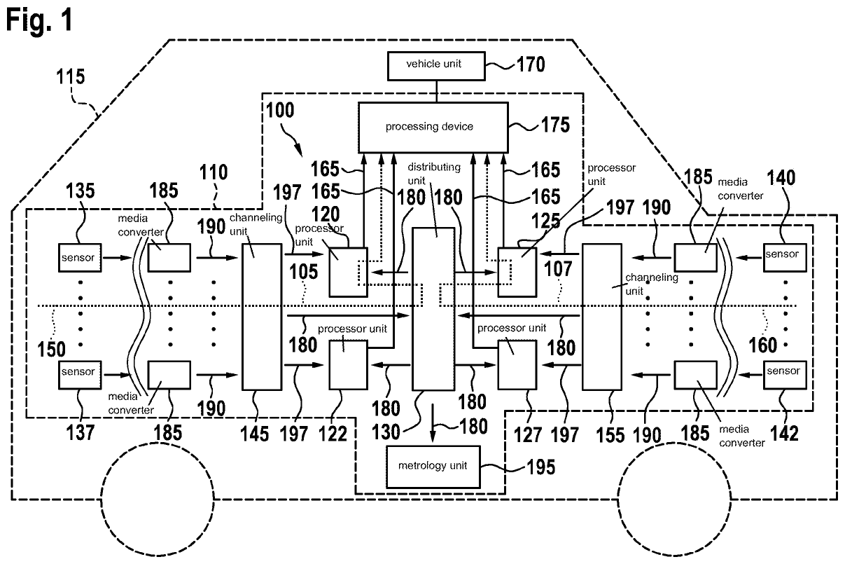

FIG. 1 shows a block diagram of a distributing device 100 for distributing data streams 105, 107 for a control unit 110 for a vehicle 115 drivable in a highly automated manner according to one exemplary embodiment.

Distributing device 100 is designed to distribute data streams 105, 107 in control unit 110 of vehicle 115 drivable in a highly automated manner shown here. Distributing device 100 is accommodated according to this exemplary embodiment in control unit 110, which is in turn accommodated in vehicle 115. For distributing data streams 105, 107, distributing device 100 includes at least one first processor unit 120, 122 and at least one further processor unit 125, 127, which are designed to process sensor data streams 105, 107. Moreover, distributing device 100 includes a distributing unit 130, which is designed to read in a first sensor data stream 105 of at least one first sensor 135, 137 and at least one further sensor data stream 107 of at least one further sensor 140, 142 and optionally distribute them onto the at least one first processor unit 120, 122 or the at least one further processor unit 125, 127. According to this exemplary embodiment, first sensor data stream 105 has been distributed onto first processor unit 120 and further sensor data stream 107 has been distributed onto further processor unit 125. All or some of sensors 135, 137, 140, 142 may be situated inside or outside control unit 110 depending on the exemplary embodiment.

The features of distributing device 100 described hereafter are optional.

Distributing device 100 according to this exemplary embodiment includes a plurality, by way of example four processor units 120, 122, 125, 127 here. Moreover, distributing device 100 according to this exemplary embodiment includes a plurality of channeling units 145, 155, which are connected between distributing unit 130 and sensors 135, 137, 140, 142. For example, a first channeling unit 145 is designed to channel a sensor raw data stream 150 from first sensors 135, 137 to first sensor data stream 105. A further channeling unit 155 is accordingly designed to channel further sensor raw data streams 160 of further sensors 140, 142 to further sensor data stream 107. Therefore, each of channeling units 145, 155 is designed to channel a plurality of sensor raw data streams of a plurality of sensors to one sensor data stream.

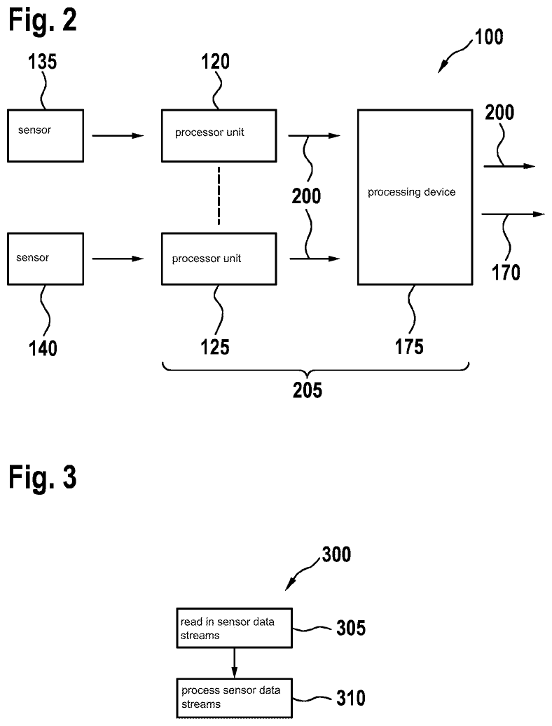

Moreover, distributing device 100 according to this exemplary embodiment includes at least one connecting unit 165, for example, an interface, which is designed to connect first processor unit 120 and/or further processor unit 125 to at least one vehicle unit 170 and/or at least one further processing device 175. According to this exemplary embodiment, further processing device 175 is part of distributing device 100. Further processing device 175 is described in greater detail in FIG. 2. Vehicle unit 170 is, for example, an actuator of vehicle 115 and includes by way of example at least one trigger unit for a passenger protection system.

First sensor 135 is formed, for example, as a surroundings detection unit and further sensor 140 is formed, for example, as an acceleration sensor.

According to this exemplary embodiment, a media converter 185 is connected in each case between sensors 135, 137 and first channeling unit 145. A media converter 185 is also situated in each case between further sensors 140, 142 and further channeling unit 155. Sensor raw data streams 150, 160 are transferred between media converters 185 and channeling units 145, 155 in the form of signals 190 according to this exemplary embodiment with the aid of 10G ethernet or according to an alternative exemplary embodiment with the aid of LVDS (low voltage differential signaling). Distributing unit 130 is additionally coupled to a metrology unit 195 according to one exemplary embodiment.

Details of distributing device 100 are described once again in greater detail hereafter:

Distributing device 100 provided here represents an effective networking structure in a control unit 110, for example, a central control unit for automated driving.

In central control units for fully automated or highly automated driving, requirements for a data throughput and a processing power are so high that in known central control units, a cluster of processors specialized for various tasks has to be accessed. To make a sequence and a distribution preferably efficient, a networking structure has advantageously been found by distributing device 100 provided here in which a dataflow preferably runs independently of other processes, intersection-free, and distributed onto different media. One goal for a good structure is to prevent bottlenecks, since only one bottleneck in the system may destroy the structure and overall performance. Such bottlenecks are advantageously avoided by distributing device 100 provided here. The possibility of processing the required quantities of data is advantageously available in the automotive field.

Due to distributing device 100, establishing an efficient data communication structure in central control units is enabled in order to distribute raw data and also enable parallel processing of the data on multiple coupled processor units 120, 125. One main feature is a distribution of data streams 105, 107, which are processed to different extents, onto different data paths/transfer media.

Specifically, this means: In the system of distributing device 100, sensor raw data in the form of sensor raw data stream 150 and further sensor raw data stream 160, visible on the left and right here, are each channeled via a programmable component in the form of channeling units 145, 155, in this case each an FPGA, and distributed as desired via a central, low-latency PCIe switch in the form of distributing unit 130 onto processor units 120, 122, 125, 127 available for processing the data. After processing in processor units 120, 122, 125, 127, the preprocessed data are distributed further via connecting units 165, with the aid of ethernet here, to the next units, further processing device 175 here. This system may be used both with a box and cascaded with further processing device 175 shown; according to this exemplary embodiment the data outputs of preprocessing boxes in the form of processor units 120, 125 are connected to sensor inputs of a further box in the form of further processing device 175, in which further processing takes place. This is shown once again in greater detail in FIG. 2. A linear dataflow is thus ensured via the entire system in the form of distributing device 100.

According to this exemplary embodiment, data streams 105, 107 are distributed with the aid of PCIe 180 onto processor units 120, 122, 125, 127. According to an alternative exemplary embodiment, a change is made to other physical interfaces to distribute data streams 105, 107 with the aid of ethernet and/or Aurora and/or LVDS onto multiple processors. According to an alternative exemplary embodiment, raw data streams 150, 160 or data streams 105, 107 may be transmitted at least partially using point-to-point connections, formed here as MIPI-CSI connections 197, to dedicated processor units 120, 122, 125, 127, a distribution of the data onto multiple processors not being possible or only being possible with great difficulty. According to one alternative exemplary embodiment, the directed and separated data paths are omitted and the data are all permitted to run via one centralized distributing entity.

A dataflow in distributing device 100 is improved in relation to a nondirected dataflow structure, whereby execution times are advantageously reduced. Distributing device 100 provided here will thus meet the increase in data throughput requirements in the automotive field, in particular for driver assistance systems.

FIG. 2 shows a block diagram of a distributing device 100 having a further processing device 175 according to one exemplary embodiment. This may be distributing device 100 described on the basis of FIG. 1. Processor units 120, 125 are connected with the aid of Ethernet 200 to further processing device 175. According to an alternative exemplary embodiment, the applications of processor units 120, 125 and further processing device 175 are associated with an identical box 205.

FIG. 3 shows a flow chart of a method 300 for distributing data streams for a control unit for a vehicle drivable in a highly automated manner according to one exemplary embodiment. This may be a method 300 which is executable by one of the distributing devices described on the basis of the preceding figures.

Method 300 includes at least one step 305 of reading in and optionally distributing and one step 310 of processing.

In step 305 of reading in and optionally distributing, at least one first sensor data stream of at least one first sensor and at least one further sensor data stream of at least one further sensor are read in and optionally distributed onto at least one first processor unit or one further processor unit. The sensor data streams are processed in step 310 of processing.

The method steps provided here may be executed repeatedly and also in a sequence other than that described.

1-10. (canceled)

11. A distributing device for distributing data streams for a control unit for a vehicle drivable in a highly automated manner, the distributing device comprising:
at least one first processor unit and at least one further processor unit, which are configured to process sensor data streams; and
a distributing unit configured to read in a first sensor data stream of at least one first sensor and at least one further sensor data stream of at least one further sensor and to distribute the read in first sensor data stream and the at least one further sensor data stream optionally to the at least one first processor unit or the at least one further processor unit.

12. The distributing device as recited in claim 11, further comprising:
a first channeling unit configured to channel a sensor raw data stream from the at least one first sensor to the first sensor data stream; and
a further channeling unit configured to channel a further sensor raw data stream from the at least one further sensor to the further sensor data stream.

13. The distributing device as recited in claim 11, further comprising:
at least one connecting unit configured to connect the first processor unit and/or the further processor unit to at least one vehicle unit and/or at least one further processing device.

14. The distributing device as recited in claim 13, further comprising the vehicle unit and/or the further processing device.

15. The distributing device as recited in claim 13, wherein the vehicle unit includes a trigger unit for a passenger protection system.

16. The distributing device as recited in claim 11, further comprising the at least one first sensor and the at least one further sensor.

17. The distributing device as recited in claim 16, wherein the at least one first sensor is a surroundings detection unit and the at least one further sensor is an acceleration sensor.

18. A method for distributing data streams for a control unit for a vehicle drivable in a highly automated manner, the method comprising the following steps:
reading in at least one first sensor data stream of at least one first sensor and at least one further sensor data stream of at least one further sensor;
distributing the read-in first sensor data stream and further sensor data stream optionally to at least one first processor unit and/or a further processor unit; and
processing the sensor data streams.

19. A non-transitory machine-readable storage medium on which is stored a computer program for distributing data streams for a control unit for a vehicle drivable in a highly automated manner, the computer program, when executed by a computer, causing the computer to perform the following steps:
reading in at least one first sensor data stream of at least one first sensor and at least one further sensor data stream of at least one further sensor;
distributing the read-in first sensor data stream and further sensor data stream optionally to at least one first processor unit or a further processor unit; and
processing the sensor data streams.
